(19) United States
(12) Patent Application Publication
(10) Pub. No.: US 2024/0248624 A1
(43) Pub. Date: Jul. 25, 2024

(54) TIERED MEMORY DATA STRUCTURES AND ALGORITHMS FOR DYNAMIC SEARCHING VIA TREAPS

(71) Applicant: VMware LLC, Palo Alto, CA (US)

(72) Inventors: Siddhartha Visveswara Jayanti, Hanover, NH (US); Marcos Kawazoe Aguilera, Mountain View, CA (US); Naama Ben David, Mountain View, CA (US)

(21) Appl. No.: 18/158,992

(22) Filed: Jan. 24, 2023

(51) Int. Cl. G06F 3/06

(52) U.S. Cl. CPC G06F 3/0638; G06F 3/0604; G06F 3/0685

(57) ABSTRACT

In one set of embodiments, a computer system can receive a request to insert or delete a key into or from a plurality of keys maintained by a dynamic search data structure, where the first memory tier is faster than the second memory tier, where the dynamic search data structure is implemented using a treap comprising a plurality of nodes corresponding to the plurality of keys, and where each node in the plurality of nodes is identified by a key in the plurality of keys and a random priority. The computer system can then execute the request in a manner that causes a threshold number of nodes of highest priority in the treap to be stored in the first memory tier.

### BACKGROUND

Unless otherwise indicated, the subject matter described in this section is not prior art to the claims of the present application and is not admitted as being prior art by inclusion in this section.

Modern computer systems use a tiered memory architecture that comprises a hierarchy of different memory types, referred to as memory tiers, with varying cost and performance characteristics. For example, the highest byte-addressable memory tier of this hierarchy typically consists of dynamic random-access memory (DRAM), which is fairly expensive but provides fast access times. The lower memory tiers of the hierarchy include slower but cheaper (or at least more cost efficient) memory types such as persistent memory, remote memory, and so on.

Because of the differences in performance across memory tiers, it is desirable for applications to place more frequently accessed data in higher (i.e., faster) tiers and less frequently accessed data in lower (i.e., slower) tiers. However, many data structures and algorithms that are commonly employed by applications today, particularly in the problem domain of searching, are not designed with tiered memory in mind. Accordingly, these existing data structures and algorithms fail to adhere to the foregoing rule, resulting in suboptimal performance.

### BRIEF DESCRIPTION OF THE DRAWINGS

FIG. 1 depicts an example tiered memory system.

FIG. 2 depicts an example treap.

FIG. 3 depicts a flowchart for implementing dynamic search using a tiered memory treap according to certain embodiments.

FIG. 4 depicts a flowchart for implementing dynamic search using a tiered memory treap comprising a min-heap and a max-heap according to certain embodiments.

FIG. 5 depicts a flowchart for implementing dynamic search using a tiered memory permutation treap according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to data structures and algorithms that may be implemented by a computer system with a tiered memory architecture (i.e., a tiered memory system) for efficiently performing dynamic searching using a treap. Generally speaking, these data structures and algorithms, referred to herein as tiered memory data structures/algorithms, ensure that most of the memory accesses needed to carry out the dynamic search task are directed to data maintained in higher (i.e., faster) memory tiers and conversely few memory accesses are directed to data maintained in lower (i.e., slower) memory tiers. This results in improved performance over standard dynamic search approaches that assume a single tier of memory.

### 1. Example Tiered Memory System and Problem Statement

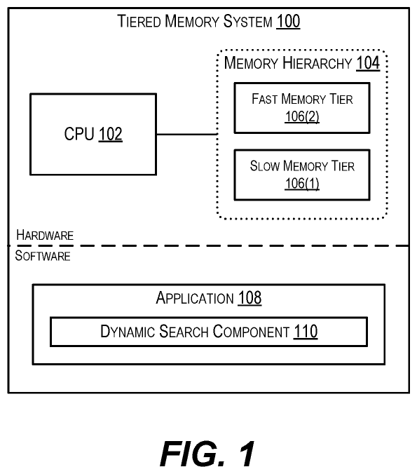

FIG. 1 is a simplified block diagram of an example tiered memory system 100 in which the techniques of the present disclosure may be implemented. As shown, tiered memory system 100 includes in hardware a central processing unit (CPU) 102 that is coupled with a memory hierarchy 104. Memory hierarchy 104 is a logical collection of memory tiers that are ordered from highest to lowest. Each memory tier represents a different type of physical memory present in tiered memory system 100 and accessed by CPU 102, with higher memory tiers consisting of faster but more expensive (and thus scarcer) memory and lower memory tiers consisting of slower but cheaper (and thus more abundant) memory.

In the example of FIG. 1, memory hierarchy 104 includes two memory tiers: a fast memory tier 106(2) (also referred to herein as simply “fast memory”) that has an associated size m and cost per memory access c, and a slow memory tier 106(1) (also referred to herein as simply “slow memory”) that has an associated size M>m and cost per memory access C>c. For example, fast memory tier 106(2) may comprise DRAM, which offers memory access times on the order of tens of nanoseconds but is typically limited in size to several hundred gigabytes. In contrast, slow memory tier 106(1) may comprise persistent memory (also known as non-volatile RAM or NVRAM), which offers slower memory access times on the order of hundreds of nanoseconds but can feasibly reach capacities of several terabytes or more. In alternative embodiments, memory hierarchy 104 may include further memory tiers beyond 106(2) and 106(1).

In addition to CPU 102 and memory hierarchy 104, tiered memory system 100 includes in software an application 108 comprising a dynamic search component 110. Dynamic search component 110 is tasked with solving the dynamic search problem, which involves implementing a data structure D (sometimes referred to herein as a dynamic search data structure) that supports the following operations:
1. D←Initialize( ): create a new instance of data structure D with an empty set of keys.
2. D.Insert(k): if key k is not in data structure D, insert k into D.
3. D.Delete(k): if key k is in data structure D, delete k from D.
4. D.HasKey(k): return whether key k is in data structure D.

In some embodiments data structure D may also store a value for each key, in which case D is referred to as a dictionary and supports an additional GetVal(k) operation that returns a value v associated with key k if k is in D. However, for simplicity, is assumed that data structure D stores only keys, with the understanding that values can be easily added.

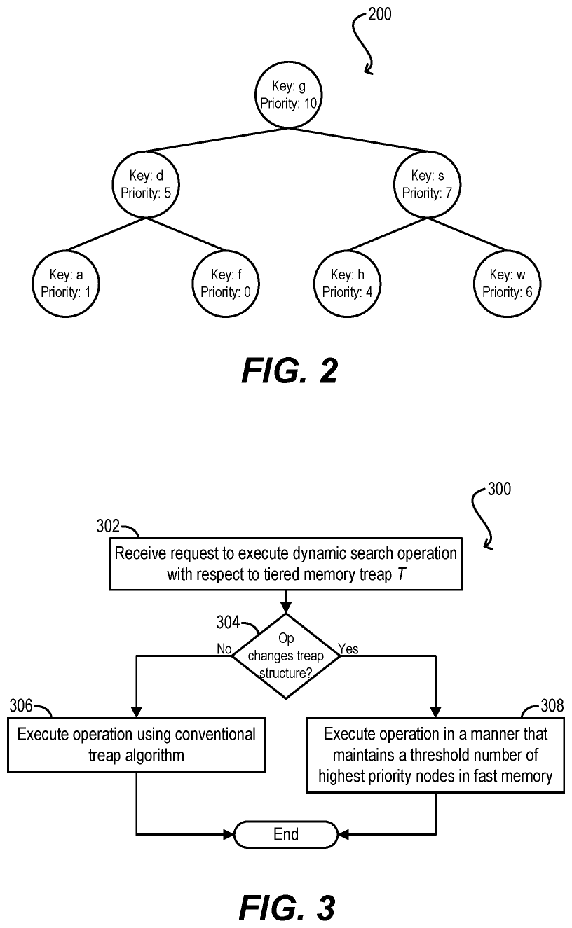

One standard algorithm for solving the dynamic search problem involves implementing data structure D using a treap that is stored in a single tier of memory. As known in the art, a treap is a rooted binary tree that holds a set of keys K and exhibits the following properties: (1) each node of the treap is identified by a key k∈K and a randomly chosen, unique priority value; (2) the nodes are binary search tree (BST)-ordered by keys, such that the key of each node is larger than the keys of all the nodes in the subtree rooted by its left child and smaller than the keys of all nodes in the right subtree rooted by its right child (known as the BST invariant property); and (3) the nodes are max-heap-ordered by priorities, such that the priority of each node is greater than or equal to the priorities of its left and right children (known as the heap invariant property). For instance, FIG. 2 depicts an example treap 200 with alphabetic keys and numeric priorities in accordance with these properties. To search for, insert, and delete keys in a treap, standard search, insert, and delete algorithms are available that ensure the treap's BST invariant and heap invariant properties are maintained. Generally speaking, these standard algorithms each involve performing a single spine (i.e., root-to-leaf path) traversal of the treap.

Because all node priorities in a treap are independent random numbers (or in other words, are in a uniformly random permutation) and are unique, a treap of |K|=n nodes has an expected depth of O(log n), which is the same as a random binary search tree (i.e., a BST formed by inserting nodes without rebalancing in a randomly chosen insertion order). This expectation, coupled with the fact that standard treap insert, delete, and search are performed as spine traversals, means that the standard algorithm noted above can perform the dynamic search Insert, Delete, and HasKey operations in expected O(log n) time.

If the size (denoted by n) of the treap that is used to implement dynamic search data structure D is guaranteed to remain less than or equal to the size of fast memory tier 106(2) of tiered memory system 100 (i.e., m), dynamic search component 110 can simply leverage the standard algorithm using fast memory tier 106(2) and thereby implement dynamic searching in a time-optimal manner. In other words, dynamic search component 110 can operate as if system 100 consists of a single memory tier corresponding to fast tier 106(2) and can perform all memory accesses required by the operations of the dynamic search problem against that tier, resulting in a total time complexity of O(c log n).

However, for purposes of the present disclosure, it is assumed that n can grow to be greater than the size of fast memory tier 106(2) (i.e., m) and less than the size of slow memory tier 106(1) (i.e., M)), with a constant (or super-constant) excess factor

$$α {=}^{Δ} \frac{n}{m}$$

indicating the proportion of the data size to the fast memory tier size. As a result, dynamic search component 110 is constrained by that fact that it may not be able to fit the entirety of the treap within fast memory tier 106(2); instead, component 110 must place at least some fraction of the treap nodes in slow memory tier 106(1) once n exceeds m. The question raised by this setting (and answered by the present disclosure) is therefore the following: how can dynamic search component 110 arrange/manipulate the nodes of the treap across fast and slow memory tiers 106(2) and 106(1) to best take advantage of the faster speed of fast memory tier 106(2) and thus accelerate the dynamic search task? Or stated another way, how can dynamic search component 110 arrange/manipulate the nodes of the treap across fast and slow memory tiers 106(2) and 106(1) to achieve a speed up over simply implementing the standard algorithm in slow memory tier 106(1) (which has a time complexity of O(C log n))?

### 2. Solution Overview

FIG. 3 depicts a flowchart 300 that provides a high level solution to the foregoing questions according to certain embodiments. Flowchart 300 assumes that data structure D of the dynamic search problem is implemented using a tiered memory treap T, which is a treap that enables a speed up over the standard algorithm in the context of a tiered memory system like system 100 of FIG. 1.

Starting with step 302 of flowchart 300, dynamic search component 110 can receive a request to execute a dynamic search operation directed to tiered memory treap T. This may be, e.g., a request to insert a new key (i.e., node) via the dynamic search Insert operation, delete an existing key/node via the dynamic search Delete operation, or search for a key/node in the treap via the dynamic search HasKey operation.

At step 304, dynamic search component 110 can determine whether the requested operation will change the structure of tiered memory treap T. If the answer is no (for example, the requested operation is simply a search), dynamic search component 110 can execute the operation in a conventional manner. For example, in the case of HasKey, dynamic search component 110 can execute the operation via the standard treap search algorithm.

However, if the answer at step 304 is yes (for example, the requested operation is an insert or delete), dynamic search component 110 can execute the operation in a manner that ensures a threshold number of highest priority in tiered memory treap T (e.g., the m highest priority nodes) are maintained in fast memory tier 106(2) and the remaining nodes are maintained in slow memory tier 106(1)) (step 306). This property is referred to herein as the tiered memory treap invariant property. Because all dynamic search operations on a treap involve performing spine traversals, by maintaining this particular property dynamic search component 110 can guarantee that most memory accesses for the dynamic search task are executed in fast memory, resulting in a speed up over the standard algorithm.

In particular, if the m nodes with highest priority in tiered memory treap T are kept in fast memory tier 106(2) and the remaining n−m nodes of T are kept in slow memory tier 106(1), every root-to-leaf traversal will take at most

$$O ( C log \frac{n}{m} + c log m ) = O ( C log α + c log m )$$

time, which is significantly faster than the worst case time complexity of the standard algorithm (i.e., O(C log n)). The mathematical reason for this is that the number of memory accesses in slow memory tier 106(1) is just logarithmic in the excess factor α rather than in the size of the entire tree (i.e., n). For example, in scenarios where n=m polylog(m) (which will be common in practice), the solution of flowchart 300 will require dynamic search component 110 to only perform O(log log n) memory accesses in slow memory tier 106(1), which is exponentially smaller than O(log n).

It should be noted that size m of fast memory tier 106(2) and size M of slow memory tier 106(2) are not necessarily the physical capacities of these memory tiers; rather, m and M are threshold memory sizes in tiers 106(2) and 106(1) respectively that dynamic search component 110 is authorized to use as part of executing the dynamic search task. In the scenario where dynamic search component 110 is the only consumer of tiers 106(2) and 106(1), m and M may be equal to their physical capacities. However, in alternative scenarios where other applications may concurrently access tiers 106(2) and 106(1), m and M may be less than the physical capacities of these tiers.

The remaining sections of this disclosure describe two specific implementations of tiered memory treap T that allow dynamic search component 110 to efficiently maintain the tiered memory treap property to achieve O(C log α+c log m) time complexity for dynamic search: a first implementation that involves representing T using two binary heaps and a second implementation that involves representing T as a permutation treap. It should be appreciated that FIGS. 1-3 are illustrative and not intended to limit embodiments of the present disclosure. For example, although dynamic search component 110 is shown as being implemented in software as part of application 108, in some embodiments the dynamic search techniques of the present disclosure may be implemented in hardware via a circuit such as a field-programmable gate array (FPGA) or an application-specific integrated circuit (ASIC). Further, although FIG. 1 depicts a particular arrangement of components within tiered memory system 100, other arrangements are possible (e.g., the functionality attributed to a particular component may be split into multiple components, components may be combined, etc.). Yet further, tiered memory system 100 may include other components or subcomponents that are not specifically described. One of ordinary skill in the art will recognize other variations, modifications, and alternatives.

### 3. Tiered Memory Treap Using Two Binary Heaps

As mentioned above, one approach for efficiently implementing the high-level solution of FIG. 3 involves implementing tiered memory treap T as two binary heaps: a min-heap H_fast stored in fast memory tier 106(2) that holds the m/2 nodes of highest priority and a max-heap H_slow stored in slow memory tier 106(1) that holds the remaining nodes. A heap is an array representation of a binary tree where each element in the array corresponds to a node of the tree and where the parent-child relationships within the tree are implicitly defined by the elements' positions (i.e., indices) in the array. A min-heap is a type of heap that requires the value held in a parent node to be less than or equal or each of the values held in the parent node's two children; thus, the value of the root node/first element of a min-heap is guaranteed to be the lowest value in the min-heap. In contrast, a max-heap is a type of heap that requires the value held in a parent node to be greater than or equal or each of the values held in the parent node's two children; thus, the value of the root node/first element of a max-heap is guaranteed to be the highest value in the max-heap.

This double heap-based approach assumes that the treap nodes in min-heap H_fast and max-heap H_slow are heap-ordered by priority and operates as follows according to certain embodiments:
To search for a key k (i.e., execute the dynamic search HasKey operation): the standard treap search algorithm is used.
To insert a new node with key k (i.e., execute the dynamic search Insert operation): A random priority is assigned to the new node and this priority is compared to the priority of the lowest priority node in fast memory (or in other words, the first element/node in min-heap H_fast). If the priority of the new node is higher, (1) the new node is added to min-heap H_fast and inserted into the treap via standard treap insert, and (2) the lowest priority node is moved from H_fast to max-heap H_slow and moved within the treap via standard treap delete and insert. Otherwise, the new node is added to max-heap H_slow and inserted into the treap via standard treap insert.
To delete an existing node with key k (i.e., execute the dynamic search Delete operation); The existing is removed from its current memory location in either min-heap H_fast or max-heap H_slow and deleted from the treap using standard treap delete. If the existing node was removed from min-heap H_fast and max-heap H_slow is non-empty (which indicates that there is space in fast memory to hold an additional node), the highest priority node in max-heap H_slow is moved from H_slow to min-heap H_fast and moved within the treap via standard treap delete and insert.

The foregoing implementation guarantees O(C log α+c log m) time complexity for the dynamic search task for the following reasons:
1. The standard treap search algorithm involves performing a single BST spine traversal to find the requested key, which can be done in O(C log α+c log m) time.
2. The insertion or deletion of a node in a treap via the standard treap insert and delete algorithms involves changing treap pointers to maintain the BST and heap invariant properties of the treap; however, because each treap node only includes three pointers (one to the parent and two the left and right children) that reference other nodes exactly one level up or down in the treap, these pointer changes can be performed in constant time.
3. Regarding insert, the lowest priority node in fast memory can be determined in constant time because this is guaranteed to be the first element in H_fast per the definition of a min-heap. Further, that lowest priority node can be moved from H_fast to H_slow in O(C log α+c log m) time because only a constant amount of work is done per heap, and the new node can be added to min-heap H_fast or max-heap H_slow in O(c log m) or O(C log α) time respectively.
4. Regarding delete, the highest priority node in slow memory can be determined in constant time because this is guaranteed to be the first element in H_slow per the definition of a max-heap. Further, that highest priority node can be moved from H_slow to H_fast in O(C log α+c log m) time because only a constant amount of work is done per heap, and the node to be deleted can be removed from min-heap H_fast or max-heap H_slow in O(c log m) or O(C log α) time respectively.
5. Each heap maintains its heap ordering implicitly via array order, and thus there is no need to store additional explicit pointers beyond the three treap pointers per node.
6. While this approach only maintains the m/2 (rather than m) highest priority nodes in fast memory, this concession is a constant factor and thus does not change the complexity of spine traversals.

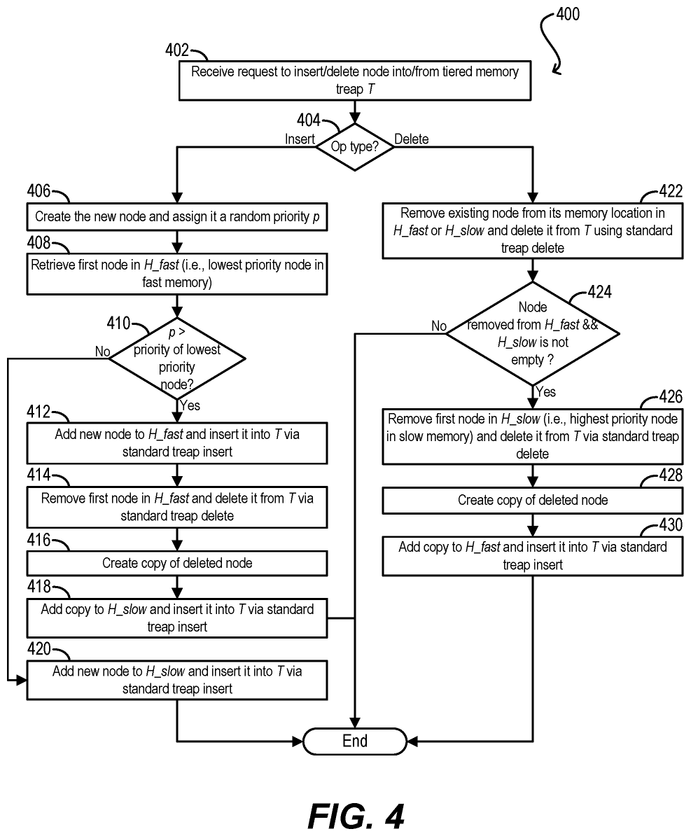

FIG. 4 depicts a flowchart 400 that summarizes the processing that may be performed by dynamic search component 110 of FIG. 1 for executing a dynamic search Insert or Delete operation in accordance with a double heap-based implementation of tiered memory treap T as described above. Starting with steps 402 and 404, dynamic search component 110 can receive a request to execute a dynamic search Insert or Delete operation with respect to tiered memory treap T and check the operation type.

If the requested operation is to insert a new node, dynamic search component 110 can create the new node and assign it a random priority p (step 406). Dynamic search component 110 can then retrieve the first node in min-heap H_fast (which is the lowest priority node of tiered memory treap T currently held in fast memory) (step 408) and check whether p is greater than the priority of that lowest priority node (step 410).

If the answer is yes, dynamic search component 110 can add the new node to min-heap H_fast and insert it into the treap via standard treap insert (step 412). Dynamic search component 110 can further remove the first node in min-heap H_fast and delete it from the treap via standard treap delete (step 414), create a copy of that deleted node (step 416), and add the copy to H_slow and insert it into the treap via standard treap insert (step 418).

However, if the answer at step 410 is no, dynamic search component 110 can add the new node to max-heap H_slow and insert it into the treap via standard treap insert (step 420).

Returning now to step 404, if the requested operation is to delete an existing node, dynamic search component 110 can remove the node from its current memory location in either min-heap H_fast or max-heap H_slow and delete it from the treap using standard treap delete (step 422). Dynamic search component 110 can then check if the node was removed from min-heap H_fast and max-heap H_slow is non-empty (step 424).

If the answer at step 424 is no, no further action is needed and the flowchart can end. However, if the answer is yes, dynamic search component 110 can remove the first node in max-heap H_slow (which is the highest priority node in slow memory) and delete it from the treap using standard treap delete (step 426), create a copy of the deleted node (step 428), and add the copy to H_fast and insert it into the treap using standard treap insert (step 430).

### 3.1 Resizing the Heaps

Due to ongoing insertions and deletions, the set of nodes in tiered memory treap T will expand and contract over time. In one set of embodiments, array doubling techniques can be used to resize heaps H_fast and H_slow appropriately in response to these changes. If the array doubling is implemented precociously, then the time complexity of dynamic search remains worst case; if the array doubling is performed on-demand, then the bound will be amortized.

### 4. Tiered Memory Permutation Treap

The foregoing double heap-based implementation allows for efficient maintenance of the tiered memory treap property but also suffers from two downsides: (1) it requires storage of a priority value per node, which increases memory requirements, and (2) it complicates treap insert and delete by employing two separate heaps. An alternative approach that eliminates/mitigates these downsides while maintaining a worst case time complexity of O(C log α+c log m) involves implementing tiered memory treap T as a permutation treap. As used herein, a permutation treap is a treap representation that does not explicitly store priorities for treap nodes; instead, the treap nodes are held in an array A[1, . . . , N] and the priority of a node x at location A[i] is derived from index i. For example, in one set of embodiments the priority of node x may be 1/i (such that lower array indices correspond to higher priorities).

The following are a set of assumptions/aspects of this premutation treap approach according to certain embodiments:
1. The first m nodes of array A (i.e., A[1, . . . , m]) are stored in fast memory tier 106(2) and the remaining element/nodes of A (i.e., A[m+1, . . . , N]) are stored in slow memory tier 106(1), thereby ensuring that the highest priority nodes of the tiered memory treap T are kept in fast memory. In alternative embodiments, array A may be allocated as two separate arrays-a first array B[1, . . . , m] in fast memory tier 106(2) and a second array C[m+1, . . . N] in slow memory tier 106(1)—and appropriate index conversions may be performed to simulate having a large single array A of size N split across fast and slow memory.
2. The size of array A (i.e., N) is assumed to be large enough to hold all of the nodes of the tree at a given time. If array A needs to be resized due to insertions/deletions, this can be achieved via array doubling techniques that are similar to those described in section 3.1 above with respect to the double heap-based approach.
3. To search for a key k (i.e., execute the dynamic search HasKey operation): the standard treap search algorithm is used, which involves performing a BST spine traversal in O(C log α+c log m) time to find the requested key.
4. To insert a new node with key k (i.e., execute the dynamic search Insert operation): Assuming there are currently n nodes in tiered memory treap T held at A[1, . . . n], a simple strategy would be to place the new node at array position A[1, . . . n+1] and use the standard treap insert algorithm to insert this node to the treap. However, the efficiency of the treap relies on the fact that its node priorities are in a uniformly random permutation, and this strategy would not make the priority of the new node random. Accordingly, a concept known as Knuth's Shuffle is employed to maintain the now n+1 nodes of tiered memory treap T in a uniformly random permutation. In particular, a random index i is chosen from 1, . . . , n+1. If i=n+1, then the new node is placed at A[n+1] and inserted into the treap via standard treap insert. Otherwise, let u be the key of the node at A[i]. The node at A[i] is removed and deleted from the treap via standard treap delete, thereby creating an opening at A[i]. A new node is created with key k, placed at A[i], and added to the treap via standard treap insert. Finally, another node is created with key u, placed at A[n+1], and added to the treap via standard treap insert. Thus, this tiered memory treap algorithm for insertion effectively moves the node at A[i] to A[i+1] and inserts the new node at A[i]. Existing work on Knuth's Shuffle ensures that this strategy maintains the treap nodes in a uniformly random permutation by priorities.
5. To delete an existing node at A[i]: A simple strategy would be to remove the node from A [i] and delete it from the treap using the standard treap delete algorithm. However, this would create a hole in the array, such that tiered memory treap T would include the nodes from A[1, . . . , i−1] and A[i+1, . . . , n] but not A[i]. To avoid this, an alternative strategy is employed that maintains the now n−1 nodes of the treap in a uniformly random permutation in subarray A[1, . . . , n−1]. In particular, if i=n, then the node is removed from A[n] and deleted from the treap via standard treap delete. Otherwise, let u be the key of the node at A[n]. The nodes at A[i] and A[n] are removed from the array and deleted from the treap via standard treap delete. Finally, a node is created with key u, placed at A [i], and inserted into the treap with standard treap insert. Thus, this tiered memory treap algorithm for deletion effectively swaps the nodes at A[i] and A[n] and deletes the node that ends up at A[n], which maintains the nodes in a uniformly random permutation by priorities.

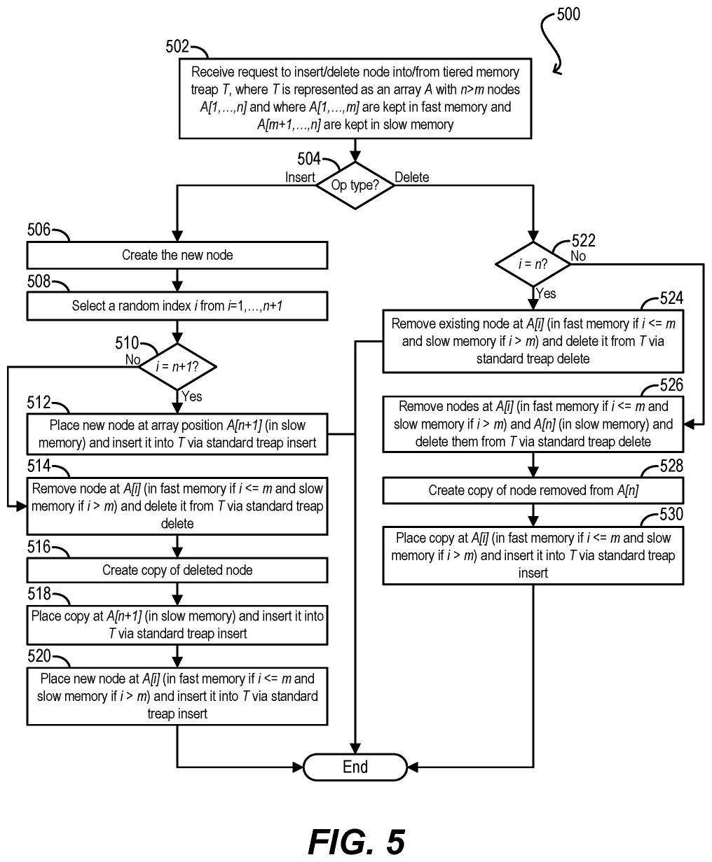

FIG. 5 depicts a flowchart 500 that summarizes the processing that may be performed by dynamic search component 110 of FIG. 1 for executing a dynamic search Insert or Delete operation in accordance with a permutation treap implementation of tiered memory treap T as described above.

Starting with step 502, dynamic search component 110 can receive a request to execute an Insert or Delete operation with respect to tiered memory treap T, where T is represented as an array A with n>m treap nodes (i.e., A[1, . . . , n]) and where the first m nodes A[1, . . . , m] are kept in fast memory tier 106(2) and the remaining n−m nodes A[m+1, . . . , n] are kept in slow memory tier 106(1). In response to receiving the request, dynamic search component 110 can check the operation type (step 504).

If the requested operation is to insert a new node, dynamic search component 110 can create the new node (step 506), select a random index i from 1, . . . , n+1 (step 508), and check whether i=n+1 (step 510). If the answer is yes, dynamic search component 110 can place the new node at array position A[n+1] (which will be in slow memory because n>m) and insert it into the treap via standard treap insert (step 512).

However, if the answer at step 510 is no, dynamic search component 110 can remove the node at A [i] and delete it from the treap via standard treap delete (step 514). Because the first m modes of array A are maintained in fast memory tier 106(2) and the remaining nodes are maintained in slow memory tier 106(1), this step will involve removing the node from either fast memory if i<=m or slow memory if i>m. Dynamic search component 110 can then create a copy of the deleted node (step 516), place the copy at A[n+1] (in slow memory) and insert it into the treap via standard treap insert (step 518), and place the new node at A[i] (in fast memory if i<=m or slow memory if i>m) and insert it into the treap via standard treap insert (step 520).

Returning now to step 504, if the requested operation is to delete an existing node at A[i], dynamic search component 110 can check whether i=n (step 522). If the answer is yes, dynamic search component 110 can remove the node from A[i] (in fast memory if i<=m or slow memory if i>m) and delete it from the treap using standard treap delete (step 524).

However, if the answer at step 522 is no, dynamic search component 110 can remove the nodes at A[n] (in slow memory) and A[i] (in fast memory if i<=m or slow memory if i>m) and delete them from the treap via standard treap delete (step 526). Finally, dynamic search component 110 can create a copy of the node removed from A [n] (step 528), place the copy at A[i] (in fast memory if i<=m or slow memory if i>m), and insert it into the treap via standard treap insert (step 530).

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by computer system including first and second memory tiers, a request to insert or delete a key into or from a plurality of keys maintained by a dynamic search data structure, wherein the first memory tier is faster than the second memory tier, wherein the dynamic search data structure is implemented using a treap comprising a plurality of nodes corresponding to the plurality of keys, and wherein each node in the plurality of nodes is identified by a key in the plurality of keys and a random priority; and
executing, by the computer system, the request in a manner that causes a threshold number of nodes of highest priority in the treap to be stored in the first memory tier.

2. The method of claim 1 wherein the treap is represented using a first binary heap stored in the first memory tier and a second binary heap stored in the second memory tier.

3. The method of claim 2 wherein the request is to insert the key and wherein the executing of the request comprises:
creating a new node including the key;
assigning a random priority to the new node;
retrieving a first node in the first binary heap corresponding to a lowest priority node in the first memory tier;
upon determining that the random priority is greater than a priority of the first node:
adding the new node to the first binary heap; and
moving the first node from the first binary heap to the second binary heap; and
upon determining that the random priority is less than or equal to the priority of the first node, adding the new node to the second binary heap.

4. The method of claim 2 wherein the request is to delete the key and wherein the executing of the request comprises:
removing an existing node including the key from the first binary heap or the second binary heap; and
upon determining that the existing node was removed from the first binary heap and that the second binary heap is non-empty, moving a first node in the second binary heap corresponding to a highest priority node in the second memory tier to the first binary heap.

5. The method of claim 1 wherein the treap is represented as an array A holding the plurality of nodes, wherein a priority of each node in array A is derived from the node's array index, and wherein the threshold number of first nodes in array A are kept in the first memory tier.

6. The method of claim 5 wherein the request is to insert the key, wherein array A currently holds n nodes of the treap at A[1, . . . , n], and wherein the executing of the request comprises:
creating a new node including the key;
selecting a random index i from i=1, . . . , n;
upon determining that i=n, placing the new node at A[n+1]; and
upon determining that i does not equal n:
removing an existing node at A[i];
creating a copy of the existing node;
placing the copy at A[n+1]; and
placing the new node at A[i].

7. The method of claim 5 wherein the request is to delete the key, wherein array A currently holds n nodes of the treap at A[1, . . . , n], wherein the key is held by an existing node at A[i], and wherein the executing of the request comprises:
upon determining that i=n, removing the existing node at A[i]; and
upon determining that i does not equal n:
removing the existing node at A[i]; and
moving another existing node at A[n] from A[n] to A[i].

8. A non-transitory computer readable storage medium having stored thereon program code executable by a computer system including first and second memory tiers, the program code embodying a method comprising:
receiving a request to insert or delete a key into or from a plurality of keys maintained by a dynamic search data structure, wherein the first memory tier is faster than the second memory tier, wherein the dynamic search data structure is implemented using a treap comprising a plurality of nodes corresponding to the plurality of keys, and wherein each node in the plurality of nodes is identified by a key in the plurality of keys and a random priority; and
executing the request in a manner that causes a threshold number of nodes of highest priority in the treap to be stored in the first memory tier.

9. The non-transitory computer readable storage medium of claim 8 wherein the treap is represented using a first binary heap stored in the first memory tier and a second binary heap stored in the second memory tier.

10. The non-transitory computer readable storage medium of claim 9 wherein the request is to insert the key and wherein the executing of the request comprises:
creating a new node including the key;
assigning a random priority to the new node;
retrieving a first node in the first binary heap corresponding to a lowest priority node in the first memory tier;
upon determining that the random priority is greater than a priority of the first node:
adding the new node to the first binary heap; and
moving the first node from the first binary heap to the second binary heap; and
upon determining that the random priority is less than or equal to the priority of the first node, adding the new node to the second binary heap.

11. The non-transitory computer readable storage medium of claim 9 wherein the request is to delete the key and wherein the executing of the request comprises:
removing an existing node including the key from the first binary heap or the second binary heap; and
upon determining that the existing node was removed from the first binary heap and that the second binary heap is non-empty, moving a first node in the second binary heap corresponding to a highest priority node in the second memory tier to the first binary heap.

12. The non-transitory computer readable storage medium of claim 8 wherein the treap is represented as an array A holding the plurality of nodes, wherein a priority of each node in array A is derived from the node's array index, and wherein the threshold number of first nodes in array A are kept in the first memory tier.

13. The non-transitory computer readable storage medium of claim 12 wherein the request is to insert the key, wherein array A currently holds n nodes of the treap at A[1, . . . , n], and wherein the executing of the request comprises:
creating a new node including the key;
selecting a random index i from i=1, . . . , n;
upon determining that i=n, placing the new node at A[n+1]; and
upon determining that i does not equal n:
removing an existing node at A[i];
creating a copy of the existing node;
placing the copy at A[n+1]; and
placing the new node at A[i].

14. The non-transitory computer readable storage medium of claim 12 wherein the request is to delete the key, wherein array A currently holds n nodes of the treap at A[1, . . . , n], wherein the key is held by an existing node at A[i], and wherein the executing of the request comprises:
upon determining that i=n, removing the existing node at A[i]; and
upon determining that i does not equal n:
removing the existing node at A[i]; and
moving another existing node at A[n] from A[n] to A[i].

15. A computer system comprising:
a processor;
a first memory tier and a second memory tier; and
a non-transitory computer readable medium having stored thereon program code that causes the processor to:
receive a request to insert or delete a key into or from a plurality of keys maintained by a dynamic search data structure, wherein the first memory tier is faster than the second memory tier, wherein the dynamic search data structure is implemented using a treap comprising a plurality of nodes corresponding to the plurality of keys, and wherein each node in the plurality of nodes is identified by a key in the plurality of keys and a random priority; and
execute the request in a manner that causes a threshold number of nodes of highest priority in the treap to be stored in the first memory tier.

16. The computer system of claim 15 wherein the treap is represented using a first binary heap stored in the first memory tier and a second binary heap stored in the second memory tier.

17. The computer system of claim 16 wherein the request is to insert the key and wherein the executing of the request comprises:
creating a new node including the key;
assigning a random priority to the new node;
retrieving a first node in the first binary heap corresponding to a lowest priority node in the first memory tier;
upon determining that the random priority is greater than a priority of the first node:
adding the new node to the first binary heap; and
moving the first node from the first binary heap to the second binary heap; and
upon determining that the random priority is less than or equal to the priority of the first node, adding the new node to the second binary heap.

18. The computer system of claim 16 wherein the request is to delete the key and wherein the executing of the request comprises:
removing an existing node including the key from the first binary heap or the second binary heap; and
upon determining that the existing node was removed from the first binary heap and that the second binary heap is non-empty, moving a first node in the second binary heap corresponding to a highest priority node in the second memory tier to the first binary heap.

19. The computer system of claim 15 wherein the treap is represented as an array A holding the plurality of nodes, wherein a priority of each node in array A is derived from the node's array index, and wherein the threshold number of first nodes in array A are kept in the first memory tier.

20. The computer system of claim 19 wherein the request is to insert the key, wherein array A currently holds n nodes of the treap at A[1, . . . , n], and wherein the executing of the request comprises:
creating a new node including the key;
selecting a random index i from i=1, . . . , n;
upon determining that i=n, placing the new node at A[n+1]; and
upon determining that i does not equal n:
removing an existing node at A[i];
creating a copy of the existing node;
placing the copy at A[n+1]; and
placing the new node at A[i].

21. The computer system of claim 19 wherein the request is to delete the key, wherein array A currently holds n nodes of the treap at A[1, . . . , n], wherein the key is held by an existing node at A[i], and wherein the executing of the request comprises:
upon determining that i=n, removing the existing node at A[i]; and
upon determining that i does not equal n:
removing the existing node at A[i]; and
moving another existing node at A [n] from A[n] to A[i].
